(19) United States
(12) Patent Application Publication
(10) Pub. No.: US 2024/0342841 A1
(43) Pub. Date: Oct. 17, 2024

(54) USE OF AN OSCILLATING MAGNETIC FIELD AS A POOL BACKING FOR ARC WELDING PROCESSES

(71) Applicant: Bundesrepublik Deutschland, vertreten durch den Bundesminister Für Wirtschaft und Energie, , dieser, Berlin (DE)

(72) Inventors: Ömar ÜSTÜNDAG, Berlin (DE); Nasim BAKIR, Berlin (DE); Andrey GUMENYUK, Berlin (DE); Michael RETHMEIER, Berlin (DE)

(73) Assignee: Bundesrepublik Deutschland, vertreten durch den Bundesminister Für Wirtschaft und Energie, , dieser, Berlin (DE)

(21) Appl. No.: 18/294,084

(22) PCT Filed: Aug. 2, 2022
(86) PCT No.: PCT/EP2022/071671

§ 371 Date: Jan. 31, 2024

(30) Foreign Application Priority Data
Aug. 13, 2021 (DE) 10 2021 121 146.8

(51) Int. Cl. B23K 37/06; B23K 9/035; B23K 9/095; B23K 9/10; B23K 101/06; B23K 101/18

(52) U.S. Cl. CPC B23K 37/06; B23K 9/035; B23K 9/0956; B23K 9/10; B23K 2101/06; B23K 2101/18

(57) ABSTRACT

An arc welding process is disclosed. In one example, the process comprises arranging an electrode at the front of a joining gap formed by joining partners contacted with opposite poles to the electrode; arranging a pair of magnetic poles at the rear or top of the joining gap and substantially centered with respect to the front electrode surface; generating the arc such that the joining partners form a welding zone comprising a weld pool with substantially simultaneous induction of a low-frequency oscillating magnetic field between the pair of magnetic poles; progressively moving the electrode along the joining gap to move the weld pool between the joining partners, leaving behind a weld seam, with synchronous entrainment of the low-frequency oscillating magnetic field. A magnetic flux density of the low-frequency oscillating magnetic field is selected such that an induced Lorentz force supports the weld pool and prevents escape from the joining gap.

### TECHNICAL AREA

The invention is in the field of welding technology and relates to a welding process and a corresponding device as a pool backing

The invention relates in particular to joining by means of arc welding
of metallic materials with a thickness of 5-120 mm, in particular from 10 to 50 mm;
of pipes and/or containers with a wall thickness of a metallic material of 5-120 mm, in particular of 10 to 50 mm.

### KNOWN STATE OF THE ART

The use of electromagnetic pool backings is known for laser beam welding and in combination with an arc welding process as a hybrid welding process. A magnet-based pool backing is not known for the pure arc welding process. However, the frequency of the alternating field used for its operation is typically above 1 kHz in order to keep the penetration depth of the magnetic field and the induced currents low so that the arc on the surface is not influenced by the magnetic fields and the induced currents. However, high frequencies (e.g. above 1 kHz) do not penetrate sufficiently deep into a weld pool (skin layer theory), so that the electromagnetically generated pressure is comparatively low and the supporting effect is therefore insufficient.

### Problem Definition

Against this background, higher magnetic power must be applied to the root at higher frequencies in order to compensate for the hydrostatic pressure of the melt. The proposed arc welding process and the electromagnetic pool backing described in connection with it are intended to achieve an increase in the depth effect of the alternating electromagnetic field and the Lorentz force induced by it in a weld pool. The weld pool is held in a joining gap between adjacent joining partners solely by capillary forces or surface tension and therefore tends to form droplets. According to the invention, the reliability of obtaining standard-compliant weld seams for material thicknesses of 5 mm to 30 mm and correspondingly deep weld pools is to be increased.

Applications primarily relate to shipbuilding, power plant and industrial plant engineering, the construction of towers and structures for wind turbines and, for example, pipeline and pipe construction.

### SOLUTION ACCORDING TO THE INVENTION

The resulting problem(s) is/are solved by a method according to claim 1. Further embodiments, modifications and improvements are shown in the following description and the appended claims.

Surprisingly, it turned out that at frequencies far below those typically used with previously known electromagnetic pool backings, the arc is not negatively influenced by external magnetic fields and the induced currents. Previous solutions were based on beam welding processes or a coupling with the arc welding process. High frequencies above 1 kHz were specifically selected in order not to negatively influence or deflect the arc on the surface. However, no quality-relevant influence on the arc was found, so that the electromagnetic weld pool backing can be used with the pure arc welding process or at a lower frequency. The weld seam quality is maintained. It is also possible to deflect the arc at right angles to the welding direction using external magnetic fields in order to increase the gap bridging capability. Furthermore, in practical implementation, a relative movement of the workpiece was always realized by an external mechanical axis, which was necessary in addition to the torch movement for a synchronous magnetic movement on the opposite side of the workpiece. This made it difficult to realize a welding process with the use of an electromagnetic pool backing, especially for longer weld seams, which is relevant for the examples described in [0005]. This invention also includes a self-moving pool backing. In contrast to the prior art, the self-moving magnetic unit eliminates the need to use an additional mechanical axis in the process.

The process is based on a combination of an arc welding process with an electromagnetic weld pool backing. In particular, at the frequencies proposed according to the invention in the range of 100 Hz-1000 Hz, a higher support effect can be achieved than was previously possible. Likewise, an increase in the gap bridging capability during arc welding and the mixing of the filler material can be significantly improved compared to previously known processes.

According to one embodiment, an arc welding process is proposed which comprises the following:
Arrangement of an electrode for generating an electric arc between the electrode and joining partners contacted with opposite poles to the electrode, so that a front electrode surface of the electrode is arranged at the front of a joining gap formed by the joining partners;
Arrangement of a pair of magnetic poles depending on a welding position at the rear or top of the joining gap formed by the joining partners and substantially centered with respect to the front electrode surface, wherein a shortest distance of each magnetic pole of the pair of magnetic poles to the joining partners is identical;
Generation of the arc in such a way that the joining partners form a welding zone comprising a weld pool in contact with or under the influence of the arc, and substantially simultaneous induction of a low-frequency oscillating magnetic field between the magnetic poles of the magnetic pole pair, the low-frequency oscillating magnetic field being oriented substantially orthogonally, i.e. transversely to a main direction of propagation of the arc;
Progressive movement of the electrode along the joining gap so that the weld pool moves between the joining partners, leaving it behind, i.e. forming a weld seam; and synchronous entrainment of the low-frequency oscillating magnetic field;
   wherein a magnetic flux density of the low-frequency oscillating magnetic field is selected such that a Lorentz force induced in the weld pool by the low-frequency oscillating magnetic field supports the weld pool in a section of the joining gap against a hydrostatic force and/or against a gravitational force and prevents the weld pool from escaping from the joining gap,
   wherein the joining partners are essentially metallic materials and a frequency of the low-frequency oscillating magnetic field is in a range from 100 to 1000 Hz, for example in a range from 200 Hz to 700 Hz, typically in a range from 400 Hz to 600 Hz.

The electromagnetic weld pool backing is advantageous compared to conventional pool backings as it can be used without contact. In addition, no negative influence on the arc was found at the frequencies proposed here, so that the electromagnetic weld pool backing can be used in pure arc welding processes.

According to one embodiment, the shortest distance between the magnetic poles of the magnetic pole pair and the joining partners is in the range of 2 mm to 3 mm or—when using magnetic pole pairs in the form of rollers-even 0 mm, so that the magnetic pool pairs rest on the joining partners or practically rest on them, or can be moved on them in a sliding manner.

The advantage of the magnetic pole pairs in the form of rollers is that they rest on the joining partners, thus eliminating the need to maintain a distance of 2 mm to 3 mm. If no rollers are to be used, it is necessary to use spacers in the range of 2 mm to 3 mm so that the distance between the magnetic pole pairs and the joining partners is kept constant in order to ensure a uniform effect of the oscillating magnetic field over the entire length of the weld seam.

According to one embodiment, a magnetic flux density of the low-frequency oscillating magnetic field is in a range of 0.1-0.3 Tesla; whereby the magnetic flux density is dynamically adjusted during welding so that a root reinforcement (penetration bead thickness) or a seam reinforcement (excess weld metal) is uniform over the entire weld seam and a predetermined reference value of the root reinforcement or seam reinforcement is not exceeded.

The advantage of dynamically adjusting the magnetic flux density during welding is that a uniform root or seam reinforcement can be guaranteed.

According to one embodiment, a profile of a root of the weld seam is recorded and evaluated with a distance meter or a laser profile scanner for dynamic adjustment of the magnetic flux density.

The advantage of measuring the root profile during welding is that it allows the system to react to changes in the root or seam reinforcement during the welding process by dynamically adjusting the magnetic flux density.

According to one embodiment, both magnetic poles are each designed as straight circular cylinders rotatable about a longitudinal axis, so that a rectilinear movement of the pair of magnetic poles and the low-frequency oscillating magnetic field along the joining gap can be achieved when they rotate identically.

The advantage of the magnetic pole pairs sitting on the joining partners is that the distance between the magnetic pole pairs and the joining partners remains identical throughout the entire welding process. This means that no additional spacers are required in the event of edge offsets between the joining partners.

According to one embodiment, the magnetic poles are arranged rotatably about their longitudinal axis and are provided with a suitable drive device, for example a stepper motor, which causes the magnetic poles to rotate and thus generates a movement of the magnetic poles along the joining gap, whereby a contactless relative temperature measurement of the temperature of the weld pool takes place, for example by means of optical pyrometry, IR thermography or an emission measurement by means of an optical camera system. A corresponding temperature probe detects a zone of maximum temperature of the weld pool and, in cooperation with a monitoring and control unit, enables the drive device to be controlled in such a way that a lateral distance between the contact point of the pair of magnetic poles and the zone of maximum temperature of the weld pool is kept constant while the welding zone progresses to form the weld seam.

Advantageously, a corresponding electromagnetic pool backing follows the advancing weld pool so that a maximum force effect can be achieved by the magnetic field on the weld pool.

According to one embodiment, the temperature probe is selected from: a pyrometer, a thermal camera or an optical camera system, which detect the position and dimension of the weld pool.

The advantage of using a temperature measurement in the root area is that the length of the weld pool can be recorded in order to generate a correction of the distance between the pair of magnetic poles and the weld pool. This allows the position of the magnet system to be adjusted using a control unit.

According to one embodiment, a distance measurement of a shortest vertical distance between the magnetic poles and the joining partners is carried out according to the proposed method. For this purpose, the device set up to carry out the proposed method has a distance sensor for measuring the shortest distance between the magnetic poles and the joining partners. The distance sensor is selected from: a tactile sensor, an inductive sensor, a capacitive sensor and an optoelectronic sensor.

The advantage of this is that the distance can be kept constant in order to achieve a uniform influence of the electromagnetic forces on the weld pool and thus a uniform root or seam reinforcement. The penetration depth of the magnetic field decreases with increasing distance to the magnetic pole pairs in the vertical direction, so that the distance between the magnetic pole pair and the joining partner has a major influence and should therefore be controlled and not changed during welding.

According to one embodiment, the joining partners comprise a metallic material. In particular, the joining partners can comprise ferromagnetic materials.

This offers the advantage of a wide range of materials to be processed. Ferromagnetic materials can be used for magnetic pole pairs in roller form to ensure adhesion to the joining partner.

According to one embodiment, the electrode is arranged in relation to the joining partners in a trough position, for example according to DIN EN ISO 6947, or in a PA welding position, in an overhead position according to DIN EN ISO 6947, or in a PE welding position, in a sheet metal transverse position or in a pipe transverse position according to DIN EN ISO 6947, or in a PC welding position.

The advantage of this is that the process can be carried out in all welding positions regardless of linear weld seams or circumferential seams.

According to one embodiment, a frequency of the low-frequency oscillating magnetic field between the magnetic poles is permanently adjusted during the progressive movement of the electrode along the joining gap so that a resonance condition is achieved and maintained by recording and permanently monitoring a phase shift between the current and the voltage of a secondary oscillating circuit used to drive the pair of magnetic poles.

The advantage of this is that optimum efficiency of the resonant circuit is guaranteed in the event of resonance. The capacitive and inductive resistance disappears as the impedance of the resonant circuit reaches its minimum value. In this case, the effective active power is maximum and only dependent on the ohmic resistance.

According to one embodiment, a device for carrying out the arc welding process described above is proposed. The device comprises:
An electrode connectable to a voltage source for generating an electric arc, comprising a front electrode surface, wherein the electrode is movable along a front side of a joining gap which can be formed between two joining partners and is arranged to induce the electric arc between the front electrode surface and the joining gap, so that a weld pool can be formed in the joining gap which, after solidification, forms a weld seam connecting the two joining partners;
   a weld pool backing, comprising:
      a pair of magnetic poles which can be arranged at the rear or top and centered with respect to the joining gap and the front electrode surface, a shortest distance between each magnetic pole of the pair of magnetic poles and the joining partners being identically adjustable; and
      an amplifier for low-frequency control of the magnetic pole pair, comprising a resonant circuit which can be adapted in such a way that a resonant frequency can be maintained;
         wherein a magnetic flux density of the low-frequency oscillating magnetic field is selected such that the weld pool which can be formed in the joining gap is supported in a section of the joining gap against a hydrostatic force and/or against a gravitational force by a Lorentz force which can be induced by the magnetic flux density, and the weld pool is prevented from escaping from the joining gap;
         wherein the joining partners essentially comprise a metallic material; and
         wherein a frequency of the low-frequency oscillating magnetic field can be controlled in a range from 100 to 1000 Hz, for example in a range from 400 Hz to 700 Hz, typically in a range from 500 Hz to 600 Hz.

The use of a contactless pool backing is therefore advantageous compared to conventional pool backings, which are mechanically attached and removed. This saves time and costs.

According to one embodiment, the weld pool backing is set up to move automatically along the joining gap formed by joining partners comprising a ferromagnetic material, the weld pool backing further comprising:
a frame to which two magnetic poles of the pair of magnetic poles, each rotatable about a longitudinal axis, are rotatably attached in the form of straight circular cylinders, so that a rectilinear movement of the pair of magnetic poles along the joining gap can be achieved when they rotate identically, whereby the weld pool backing is held in a sliding manner on the joining partners by means of magnetic force.

The advantage of this is that there is no need for a mechanical axis to guide the magnet below or above the joining partners. The magnet can therefore move itself.

According to one embodiment, the weld pool backing further comprises a drive device for generating a rotation of the magnetic poles and for moving the low-frequency oscillating magnetic field forward synchronously with a movement of a zone of maximum temperature of the weld pool in the joining gap.

The advantage of this is that the emerging melt is positioned in an area where a maximum support effect can be achieved by the oscillating magnetic fields in order to counteract the gravitational force. This allows the magnetic force to be used effectively.

According to one embodiment, the weld pool backing further comprises a temperature probe for measuring a temperature of the weld pool which can be formed in sections in the joining gap, wherein the temperature probe is set up to detect the zone of maximum temperature of the weld pool and to control the drive device—for example in interaction with a monitoring and control unit—in such a way that a distance between the pair of magnetic poles and the zone of maximum temperature of the weld pool can be maintained constant when the weld pool progresses while forming between the two joining partners of the weld seam.

The advantage of this is that a constant support effect can be set by the magnetic forces during the entire welding process. Temperature measurements can be used to identify the weld pool and adjust the position of the magnet.

According to one embodiment, the weld pool backing further comprises a monitoring and control unit which is set up to control the rotation of the magnetic poles generated by the drive device in such a way that a movement of the weld pool along the joining gap, which is determined by data from the temperature probe, causes a synchronous movement of the weld pool backing; wherein the monitoring and control unit is further set up to dynamically adjust a magnetic flux density during welding in such a way that an reinforcement of the root of the weld seam or a seam reinforcement is uniform over the entire weld seam and that a predetermined reference value of the root or seam reinforcement is not exceeded or a seam reinforcement is uniform over the entire weld seam and that a predetermined reference value of the root or seam reinforcement is not exceeded.

According to one embodiment, the temperature probe is selected from: a pyrometer and a thermal camera.

The advantage here is that the temperature can be measured contactlessly through the magnetic gap using an optical system.

According to one embodiment, the device further comprises a distance sensor for measuring a shortest distance between the magnetic poles and the joining partners, wherein the distance sensor is selected from: an inductive sensor, a capacitive sensor, and an optoelectronic sensor.

The advantage of this is that the weld seam profile resulting during welding can be recorded and the power of the magnet system can be adjusted if necessary.

According to one embodiment, a self-propelled weld pool backing for supporting a weld pool in a joining gap formed by joining partners adjacent to each other is proposed, comprising the following:
A device for carrying out an arc welding process according to one of the above-mentioned embodiments, comprising at least one frame with a pair of magnetic poles rotatably mounted thereon, which has two magnetic poles in the form of straight circular cylinders, each rotatable about a longitudinal axis, so that when they rotate identically, a substantially rectilinear movement of the pair of magnetic poles along the joining gap can be achieved, wherein the self-propelled weld pool backing remains in continuous contact with the joining partners by means of magnetic force, wherein the pair of magnetic poles can be controlled in such a way that a low-frequency oscillating magnetic field can be formed by the two magnetic poles, wherein a magnetic flux density of the low-frequency oscillating magnetic field is selected in such a way that a Lorentz force can be generated in the weld pool which can be formed in sections in the joining gap and which supports the weld pool against a hydrostatic force and/or against a gravitational force; and
A drive device for generating a rotation of the magnetic poles and for moving the low-frequency oscillating magnetic field forward synchronously with a movement of the weld pool in the joining gap, or synchronously with a movement of the arc used for welding.

According to one embodiment, the self-propelled weld pool backing further comprises a temperature probe for measuring a temperature of the weld pool which can be formed in sections in the joining gap, wherein the temperature probe is arranged to detect a zone of maximum temperature of the weld pool and to control the drive device in interaction with a monitoring and control unit in such a way that a distance between the pair of magnetic poles of the weld pool backing and the zone of maximum temperature of the weld pool is kept constant when the welding zone progresses to form a weld seam between the two joining partners.

According to one embodiment, the aforementioned monitoring and control unit is set up to control an amplifier in such a way that a low-frequency oscillating circuit can be adjusted so that a resonant frequency is maintained during the entire welding process.

The advantage of this is that it increases the efficiency of the process and reduces unnecessary energy losses.

According to one embodiment, it is proposed to use the self-propelled weld pool backing described above to generate a Lorentz force in a weld pool formed in sections in a joining gap, wherein a magnetic flux density of a low-frequency oscillating magnetic field is selected such that a predetermined reinforcement of a root of a weld seam or a seam reinforcement is uniform over the entire weld seam and a predetermined reference value of the root or seam reinforcement is not exceeded.

The advantage here is that the standard value for the root or seam reinforcement can be selected based on the requirements for the welded joint.

The embodiments described above can be combined with one another as desired. However, the invention is not limited to the embodiments specifically described, but can be suitably modified and altered. It is within the scope of the invention to suitably combine individual features and combinations of features of one embodiment with features and combinations of features of another embodiment in order to arrive at further embodiments according to the invention.

In the figures referred to below, identical elements are marked with the same or similar reference signs and a repeated description of these elements is omitted. Furthermore, the figures are not necessarily to scale, the emphasis is rather on explaining the basic principle of the proposed technical solution.

### FIGURES

FIG. 1: Schematic illustration of an oscillating magnetic field as a pool backing in the arc welding process (rear side) in the flat position (PA welding position)

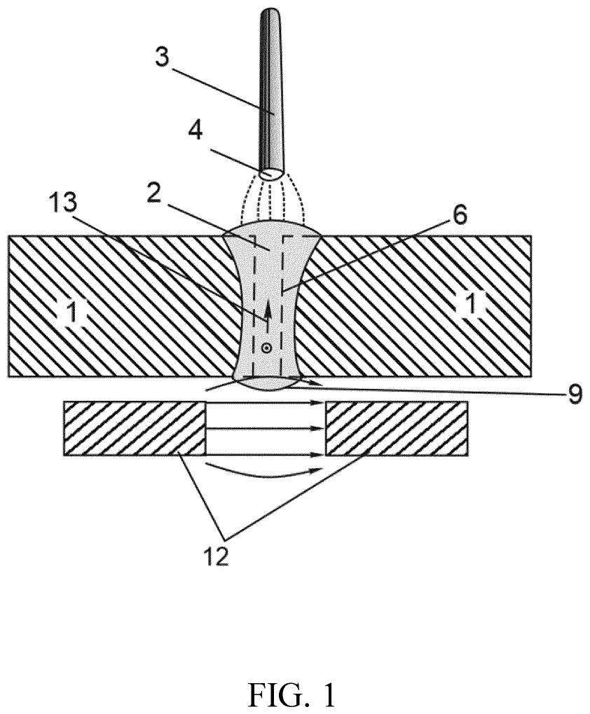

FIG. 2: Schematic illustration of an oscillating magnetic field as a pool backing in the arc welding process (overhead) in the overhead position (PE welding position)

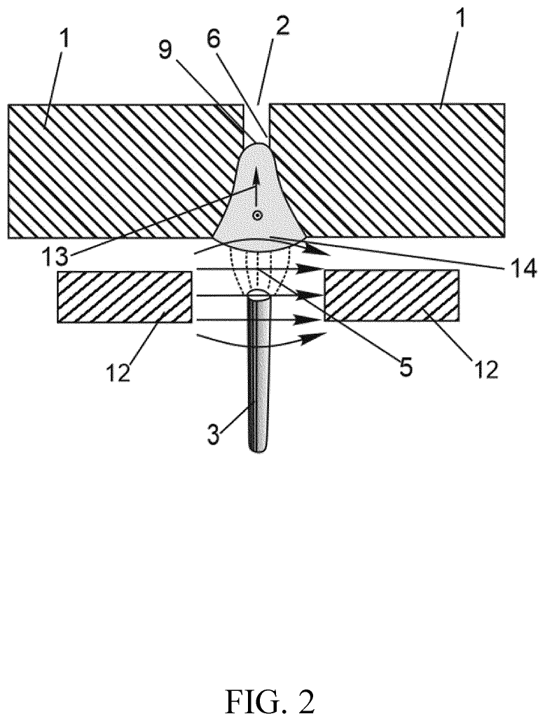

FIG. 3: Schematic illustration in side view of an oscillating magnetic field as a pool backing in the arc welding process (rear side) in flat position (PA/4G welding position)

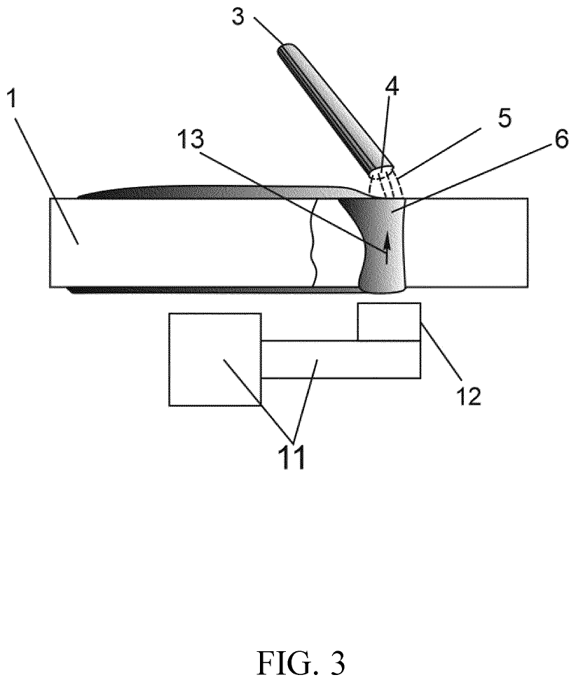

FIG. 4: Schematic illustration of an oscillating magnetic field as a pool backing in the arc welding process in the trough position (PA welding position) with a pair of magnetic poles as rollers (on the back)

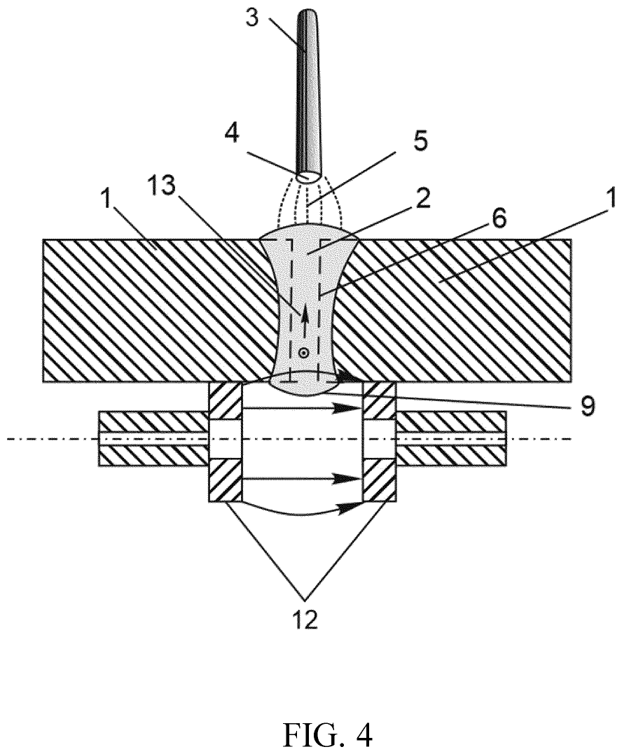

FIG. 5: Schematic illustration of an oscillating magnetic field as a pool backing in the arc welding process in the overhead position (PE welding position) with a pair of magnetic poles as rollers (with the arc welding process on one side)

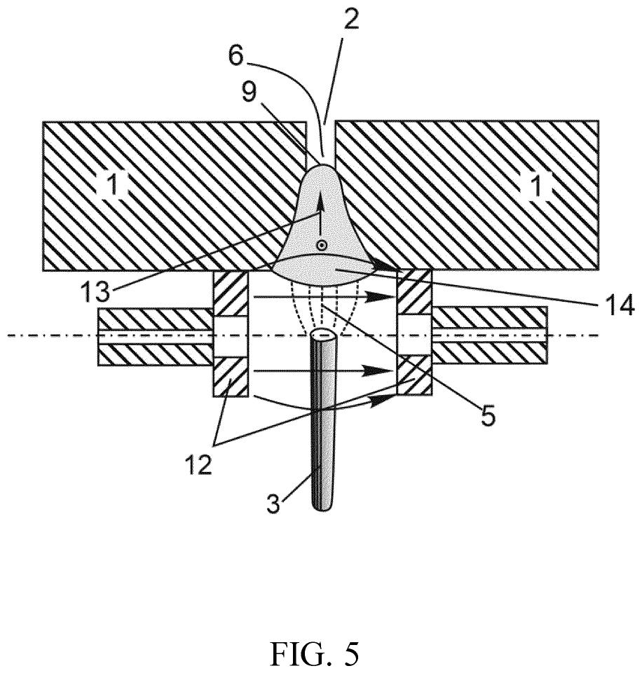

FIG. 6: Schematic illustration of an oscillating magnetic field as a pool backing with two magnet systems in the arc welding process for an orbital welding application

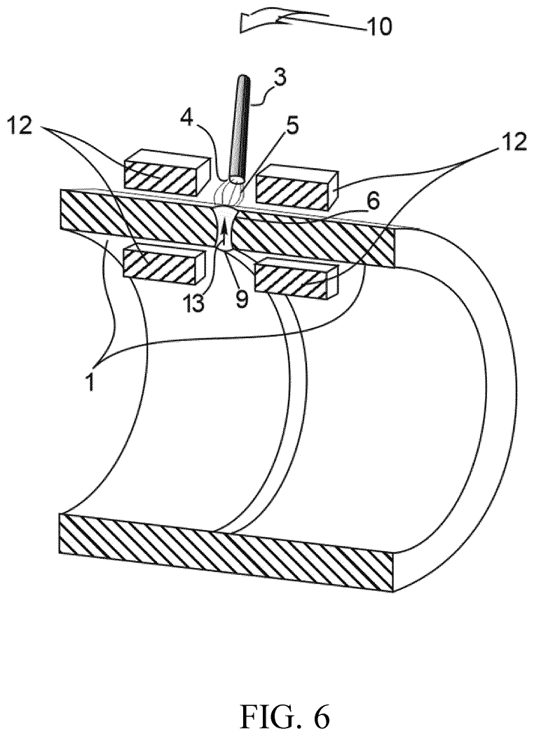

FIG. 7: Illustrations for the definition of the terms seam reinforcement (A); seam undercut (B); root reinforcement (C) and root concavity (D) in accordance with DIN EN ISO 5817:2014-06 for sheets with a sheet thickness of >3 mm

The process proposed at the beginning can be used for all metallic materials.

Aspects of the above embodiments can be described in the form of the following key points:
1. The direction of the magnetic field can be parallel, perpendicular or at any angle to the welding direction and preferably (but not exclusively) in a plane parallel to the surface of the workpiece. The externally applied oscillating magnetic field can serve as a pool backing, to prevent droplet formation on the root side or on the seam surface (depending on the welding position), for electromagnetic stirring or mixing and for targeted deflection of the arc to increase gap bridging capability. By means of a parallel arrangement of the magnetic field, the arc can be directed in such a way that it runs transverse to the welding direction and thus the welding gap is reliably bridged or the gap-bridging capability is increased. Previous patents or publications show a magnetic field applied parallel or at any other angle to the welding direction in order to avoid droplet formation or to ensure better mixing of the weld pool in the beam welding process or in a combination of another welding process with a beam welding process.
2. The Lorenz force resulting from the effect of the oscillating magnetic field is oriented vertically to the workpiece surface and preferably (but not exclusively) acts in a direction that runs counter to the gravitational force. According to one embodiment, a second magnet system can be used on the side of the arc at a distance from it and possibly separated by a non-magnetic separating plate. The second magnet system is controlled independently of the first magnet system. The new process proposed here can be used in all welding directions, including in the PA position (flat position), PE/4G position (overhead position), PC position, in particular in the sheet metal transverse position (2G) or in the pipe transverse position (pipe fixed, vertical axis; 2G). In the overhead position, the arrangement of the magnetic field must be adapted accordingly. Previous publications referred exclusively to welds in the PA position.
3 The position of the magnetic poles is selected so that maximum effect is achieved in the molten zone. The magnet system can be positioned dynamically during the process. The length of the weld pool is determined using the measuring equipment described, which enables non-contact temperature measurement. In previous studies, this point was not taken into account, so the laser beam was positioned in the middle of the magnetic poles.
4. The method can be used for metallic materials that have paramagnetic or ferromagnetic properties at room temperature. For ferromagnetic materials that have a Curie point, the largest proportion of the magnetic field is localized in the area that lies above the Curie temperature. For this purpose, the position of the magnet system is always dynamically adjusted as the welding zone progresses. Contactless temperature measurement using a pyrometer or thermal camera is used to determine the length of the weld pool, for example. Depending on the values determined, the movement of the weld pool backing is adjusted by means of feedback, for example. This allows the magnetic poles and thus the electromagnetic pool backing to be optimally positioned dynamically both in relation to the gap and in the welding direction.
5. The distance between the magnetic poles and the workpiece surface is zero to a few millimeters. According to one embodiment, for example, a predetermined value is set between the magnetic poles and the workpiece surface using mechanical sliding elements. According to one embodiment, for a desired distance between the magnetic poles and the surface of the workpiece of zero millimeters, the magnetic poles are designed as rollers with rotating axes. According to one embodiment, the magnetic pole pair is held at a predetermined distance from the workpiece solely by the magnetic attraction force to the semi-finished product (e.g. a sheet or a tube). Movement of the pair of magnetic poles relative to the workpiece can be achieved, for example, by external axes or with the welding robot depending on the welding position.
6. The strength of the magnetic field applied in each case depends on the desired force effect on the weld pool surface and can be adjusted during the welding process according to embodiments. For this purpose, a magnetic flux density generated in each case is either increased or decreased. For this purpose, the welding profile on the root side or the workpiece surface facing the magnet is recorded during the welding process, e.g. using a distance meter or a laser profile scanner, and the values determined are evaluated. The desired force effect can then be adjusted by dynamically adapting the magnetic field strength so that the root reinforcement or the seam reinforcement is uniform over the entire weld seam and the guide values specified in the applicable standards are not exceeded.

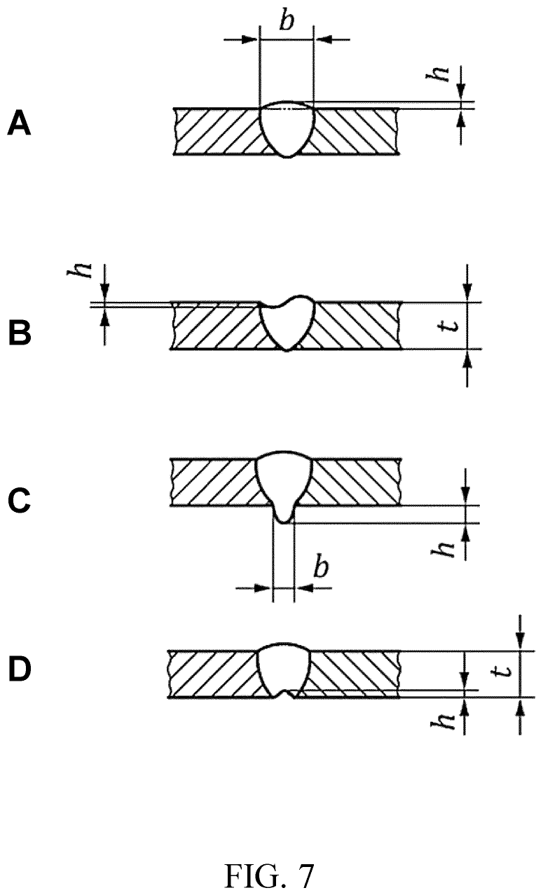

This makes it possible, for example, for sheets with a sheet thickness of >3 mm to comply with the limit values for the highest evaluation class B in accordance with the relevant standards, for example DIN EN ISO 5817:2014-06. For example, a seam reinforcement h (see FIG. 7A) of less than or equal to 1 mm+0.1 b (b=weld pool width) is maintained, whereby h is a maximum of 5 mm. Similarly, a seam undercut h (see FIG. 7B), typically only a short irregularity, of h≤0.05 t (t=sheet thickness), but max. 0.5 mm is maintained. The electromagnetic weld pool backing described enables compliance with the criteria of the highest evaluation class B for a weld seam. The surface of the weld seam is therefore between the specified h value of a permissible seam undercut and the h value of the permissible seam camber.

The same applies to the root reinforcement h (see FIG. 7C), i.e.: root reinforcement h≤1 mm+0.2 b (b=weld pool width on the root side), but maximum only 3 mm; and for a root concavity h (see FIG. 7D), i.e. a short irregularity, h≤0.05 t (t=sheet thickness), but maximum only 0.5 mm. A permissible root geometry should lie within or between the specified ranges. Here, an irregularity in welds that are 100 mm or longer is defined as short if the irregularity lies in a section of 100 mm that contains the most irregularities and does not exceed a total length of 25 mm.
7. The oscillation frequency of the magnetic field is based on the principle of skin layer theory. For example, the oscillation frequency can be changed or adjusted during the welding process depending on the desired seam reinforcement. The phase image (i.e. the phase shift between the current and the voltage in the secondary oscillation circuit) is recorded over the entire weld seam and—as soon as the magnetic system is not in resonance mode—the oscillation frequency is adjusted. This ensures that the magnetic field has maximum effect and that the necessary power from the amplifier is optimally utilized.
8. During welding, the magnet is moved in relation to the workpiece at the same speed as the arc. An additional drive or an additional axis for the magnet is used for this purpose. Feedback from the welding process is used to dynamically adjust the position of the magnet during the welding process. This can be based on contactless temperature measurements, for example.
9 According to one embodiment, the magnet system is designed as a self-propelled (autonomous) system so that the magnet, and thus the pool backing, adheres to the metallic material solely through the force of attraction. A drive allows the magnetic rollers to move relative to the workpiece so that the magnetic system is moved forward. By continuously detecting the localization of the weld pool, for example with a temperature probe, and controlling the drive (the above-mentioned feedback system), the pool backing follows the continuously advancing arc during the welding process and thus ensures a constant quality of the weld seam over its entire length.

Although specific embodiments have been shown and described herein, it is within the scope of the present invention to suitably modify the embodiments shown without departing from the scope of protection of the present invention. The following claims represent a first, non-binding attempt to define the invention in general terms.

### LIST OF REFERENCE SYMBOLS

1—Joining partner
2—Joining gap
3—Electrode
4—Front electrode surface
5—Arc
6—Weld pool
7—Welding zone
8—Weld seam
9—Root
10—Direction of movement of the electrode/weld pool
11—Solenoid coil with core
12—Pair of magnetic poles
13—Lorentz force
14—Seam reinforcement
h—Seam reinforcement, —undercurvature; root reinforcement, —relapse
b—weld pool width
t—sheet thickness

1. Arc welding process, comprising:
arranging an electrode for generating an electric arc between the electrode and joining partners contacted with opposite poles to the electrode, so that a front electrode surface of the electrode is arranged at the front of a joining gap formed by the joining partners;
arranging a pair of magnetic poles depending on a welding position at one of a rear and a top of the joining gap formed by the joining partners and substantially centered with respect to the front electrode surface, wherein a shortest distance of each magnetic pole of the pair of magnetic poles to the joining partners is identical;
generating the arc in such a way that the joining partners together form a welding zone comprising a weld pool and substantially simultaneous induction of a low-frequency oscillating magnetic field between the magnetic poles of the pair of magnetic poles, the low-frequency oscillating magnetic field being oriented substantially orthogonally to a main direction of propagation of the arc; progressively moving the electrode along the joining gap so that the weld pool moves between the joining partners, leaving behind a weld seam; and synchronous entrainment of the low-frequency oscillating magnetic field;
wherein a magnetic flux density of the low-frequency oscillating magnetic field is selected such that a Lorentz force induced by the low-frequency oscillating magnetic field in the weld pool supports the weld pool against a hydrostatic force and prevents the weld pool from escaping from the joining gap,
wherein the joining partners are essentially metallic materials and a frequency of the low-frequency oscillating magnetic field is in a range from 100 to 1000 Hz.

2. The are welding method according to claim 1, wherein the shortest distance between the magnetic poles of the magnetic pole pair and the joining partners is one of in a range of 2-3 mm and 0 mm when using magnetic pole pairs in the form of rolls.

3. The arc welding method according to claim 1, wherein
a magnetic flux density of the low-frequency oscillating magnetic field is in a range of 0.1-0.3 Tesla; and
wherein the magnetic flux density is dynamically adjusted during welding so that at least one of a root reinforcement and a seam reinforcement is uniform over the entire weld and a predetermined reference value of at least one of the root and seam reinforcement is not exceeded.

4. The welding method according to claim 3, wherein a profile of a root of the weld seam is recorded and evaluated with at least one of a distance meter and a laser profile scanner for dynamic adaptation of the magnetic flux density.

5. The arc welding method according to claim 1, wherein both magnetic poles are each designed as straight circular cylinders rotatable about a longitudinal axis, so that a rectilinear movement of the pair of magnetic poles and of the low-frequency oscillating magnetic field along the joining gap can be achieved during their rotation.

6. The arc welding method according to claim 5, wherein the magnetic poles are arranged rotatably about their longitudinal axis and a drive device effects a rotation of the magnetic poles, and wherein a contactless relative temperature measurement of the weld pool takes place, wherein a temperature probe detects a zone of maximum temperature of the weld pool and enables such a control of the drive device that a distance between the pair of magnetic poles and a zone of maximum temperature of the weld pool is kept constant when the welding zone progresses to form the weld seam.

7. The arc welding method according to claim 6, wherein the temperature probe is selected from: a pyrometer, a thermal camera and an optical camera system, and the temperature probe detects a position and a dimension of the weld pool.

8. The arc welding method according to claim 6, wherein the frame further comprises at least one distance sensor for measuring a distance between the magnetic poles and the joining partners, selected from: a tactile sensor, an inductive sensor, a capacitive sensor, and an optoelectronic sensor.

9. The arc welding method according to claim 1, wherein the joining partners comprise a metallic material.

10. The arc welding method according to claim 1, wherein the electrode is arranged in one of a flat position, an overhead position, a sheet metal transverse position, and a tube transverse position relative to the joining partners.

11. The arc welding method according to claim 1, wherein a frequency of the low-frequency oscillating magnetic field between the magnetic poles is adjusted during the progressive movement of the electrode along the joining gap so that a resonance condition is maintained by recording and permanently monitoring a phase shift between the current and the voltage of a secondary oscillating circuit used to drive the pair of magnetic poles.

12. An apparatus for performing an arc welding process, comprising:
an electrode which can be connected to a voltage source for generating an electric arc, having a front electrode surface, the electrode being movable along a front side of a joining gap which can be formed between two joining partners and being designed to induce the arc between the front electrode surface and the joining gap, so that a weld pool can be formed in the joining gap, which, after solidification, forms a weld seam connecting the two joining partners;
a weld pool backing comprising:
a pair of magnetic poles which can be arranged at one of the rear and top and centered with respect to the joining gap and the front electrode surface, a shortest distance between each magnetic pole of the pair of magnetic poles and the joining partners being identically adjustable; and
an amplifier for low-frequency control of the magnetic pole pair, comprising a resonant circuit which can be adapted in such a way that a resonant frequency can be maintained:
wherein a magnetic flux density of the low-frequency oscillating magnetic field is selected such that the weld pool which can be formed in the joining gap supports the weld pool in a section of the joining gap against a hydrostatic force by a Lorentz force which can be induced by the magnetic flux density and prevents the weld pool from escaping from the joining gap;
wherein the joining partners essentially comprise a metallic material and a frequency of the low-frequency oscillating magnetic field can be regulated in a range

13. The apparatus according to claim 12, wherein the weld pool backing is arranged to move self-propelled along the joining gap formed by joining partners comprising a ferromagnetic material, wherein the weld pool backing further comprises:
a frame on which two magnetic poles of the magnetic pole pair, each rotatable about a longitudinal axis, are rotatably mounted in the form of straight circular cylinders, so that a movement of the magnetic pole pair along the joining gap can be achieved when they rotate, the weld pool backing being held sliding on the joining partners by means of magnetic force.

14. The apparatus according to claim 13, wherein the weld pool backing further comprises a driving device for generating a rotation of the magnetic poles and for advancing the low-frequency oscillating magnetic field in synchronization with a movement of a zone of a maximum temperature of the weld pool in the joining gap.

15. The apparatus according to claim 14, wherein the weld pool backing further comprises a temperature probe for measuring a temperature of the weld pool which can be formed in sections in the joining gap, wherein the temperature probe is set up to detect the zone of maximum temperature of the weld pool and to control the drive device in such a way that a distance between the pair of magnetic poles and the zone of maximum temperature of the weld pool can be maintained constant when the weld pool advances to form the weld seam between the two joining partners.

16. The apparatus according to claim 15, wherein the weld pool backing further comprises a monitoring and control unit which is set up to control the rotation of the magnetic poles generated by the drive device in such a way that a movement of the weld pool along the joining gap determined by data from the temperature probe causes a synchronous movement of the weld pool backing; and the monitoring and control unit is further set up to dynamically adjust a magnetic flux density during welding in such a way that at least one of a reinforcement of the root of the weld seam and a seam reinforcement is uniform over the entire weld seam, and least one of a predetermined reference value of the root and a seam reinforcement is not exceeded.

17. The apparatus device according to claim 15, wherein the temperature probe is selected from: a pyrometer and a thermal camera.

18. The apparatus according to claim 12, further comprising:
a distance sensor for measuring a distance between the magnetic poles and the joining partners, which is selected from: an inductive sensor, a capacitive sensor, and an optoelectronic sensor.

19. Self-propelled weld pool backing for supporting a weld pool in a joining gap formed by adjacent joining partners, comprising:
device for carrying out an arc welding process according to claim 12, comprising at least one frame with a pair of magnetic poles rotatably attached thereto, which comprises two magnetic poles in the form of straight circular cylinders, each rotatable about a longitudinal axis, so that a movement of the pair of magnetic poles along the joining gap can be achieved when they rotate,
wherein the self-propelled weld pool backing remains in contact with the joining partners, the pair of magnetic poles being controllable in such a way that a low-frequency oscillating magnetic field can be formed by the two magnetic poles, wherein a magnetic flux density of the low-frequency oscillating magnetic field is selected such that a Lorentz force can be generated in the weld pool, which can be formed in sections in the joining gap, which supports the weld pool against a hydrostatic force and/or against a gravitational force; and
a drive device for generating a rotation of the magnetic poles and for advancing the low-frequency oscillating magnetic field synchronously with a movement of the weld pool in the joining gap.

20. A self-propelled weld pool backing according to claim 19, further comprising
a temperature probe for measuring a temperature of the weld pool which can be formed in sections in the joining gap, the temperature probe being set up to detect a zone of maximum temperature of the weld pool and to control the drive device in interaction with a monitoring and control unit such that a distance between the pair of magnetic poles and the zone of maximum temperature of the weld pool can be maintained constant as the welding zone progresses with the formation of a weld seam between the two joining partners.

21. A self-propelled weld pool backing according to claim 20, wherein the monitoring and control unit is set up to control an amplifier in such a way that a low-frequency oscillating circuit can be adapted in such a way that a resonant frequency can be maintained.

22. A method of using a self-propelled weld pool backing according to claim 19, for generating a Lorentz force in a weld pool formed in sections in a joining gap, wherein a magnetic flux density of a low-frequency oscillating magnetic field is selected such that at least one of a predetermined reinforcement of a root of a weld seam or a seam reinforcement is uniform over the entire weld seam and at least one of a predetermined reference value of the root or seam reinforcement is not exceeded.
